(19) United States
(12) Patent Application Publication
(10) Pub. No.: US 2026/0138257 A1
(43) Pub. Date: May 21, 2026

(54) HAPTIC MODAL FEEDBACK

(71) Applicant: Hubbell Incorporated, Shelton, CT (US)

(72) Inventor: Benjamin Stanley Prescott, Pembroke, NH (US)

(21) Appl. No.: 19/395,277

(22) Filed: Nov. 20, 2025

Related U.S. Application Data
(60) Provisional application No. 63/723,302, filed on Nov. 21, 2024.

(51) Int. Cl. B25F 5/02; B25F 5/00; H02K 7/14; H02K 11/20

(52) U.S. Cl. CPC B25F 5/02; B25F 5/001; H02K 7/145; H02K 11/20

(57) ABSTRACT

A power tool that includes a housing, a working portion coupled to the housing, a motor, an acoustic plate disposed within the housing, and a controller that can drive the motor. The housing has a gripping portion that can be grasped by an operator. The motor is supported in the housing and can drive the working portion. The acoustic plate can vibrate during operation of the motor and transmit a haptic signal to the gripping portion that can be felt by the operator.

### CROSS-REFERENCE TO RELATED APPLICATION:

This application claims the benefit of U.S. Provisional Ser. No. 63/723,302, filed Nov. 21, 2024, the contents of which is incorporated by reference herein in its entirety.

### FIELD

The present disclosure relates to a power tool. More particularly, the present disclosure relates to haptic feedback in a power tool.

### BACKGROUND

A power tool (e.g., a battery-operated power tool) may be used to perform a cyclical function. For example, the power tool may be used to perform a mechanical crimp. The tool may cycle (e.g., with a hydraulic ram) between a first or retracted position and a second or extended position where the crimping occurs.

When in use, it may be important to avoid over-cycling the tool. For example, an operator may wish to avoid extending the ram past the second position or maintaining the ram in the second position for an extended period of time. To alert an operator that the tool has reached the second position and limit the overextension of the ram, the tool may include a feedback mechanism.

In some examples, the feedback mechanism may include one or more visual indicators (e.g., LEDs). These indicators may illuminate, change colors, and/or change patterns to communicate information to the operator. However, the movement of the tool (e.g., rotation of the tool head) may obstruct the operator's view of the indicators and/or the operator may not be paying attention to the indicators. In either case, the operator may miss the information communicated by the tool.

Other examples of power tools may include valves to provide a tactile indication. For example, the tool may include one or more poppet valves, which can provide a tactile indication when the tool has reached the end of a cycle. However, the valves add mechanical complexity to the tool and increase potential points of failure.

A need exists for a power tool that includes a way to better alert communicate information to an operator that is less likely to be missed and/or create additional points of failure in the tool.

### SUMMARY

Various examples of the present disclosure can overcome various of the aforementioned and other disadvantages associated with known power tools and offer new advantages as well.

According to one aspect of examples of the present disclosure, there is provided a power tool with a plate for producing a haptic response.

According to one aspect of examples of the present disclosure, there is provided a power tool with an acoustic plate coupled to a motor drive shaft. The acoustic plate can produce vibrations during specific use conditions of the power tool.

According to one aspect of examples of the present disclosure, there is provided a power tool with an acoustic plate disposed within a tool housing. The acoustic plate can produce vibrations during specific use conditions of the power tool.

According to one aspect of various examples of the present disclosure there is provided a power tool that includes a housing, a working portion coupled to the housing, a motor, an acoustic plate disposed within the housing, and a controller that can drive the motor. The housing has a gripping portion that can be grasped by an operator. The motor is supported in the housing and can drive the working portion. The acoustic plate can vibrate during operation of the motor and transmit a haptic signal to the gripping portion that can be felt by the operator.

According to another aspect of various examples of the present disclosure, there is provided a power tool that includes a movable working portion, a motor, an acoustic plate, and a controller that can drive the motor. The motor includes a drive shaft coupled to the working portion and can drive the movement of the working portion. The acoustic plate is coupled to the drive shaft. The acoustic plate can vibrate during rotation of the drive shaft and output a haptic signal that can communicate an operational state.

According to another aspect of various examples of the present disclosure, there is provided a power tool that includes a housing, a motor supported in the housing and having an asymmetrical shaft, an acoustic plate coupled to the motor shaft, and a controller electrically coupled to the motor. The housing has a gripping portion that can be grasped by an operator. The controller can drive the motor to rotate the motor shaft in a first pattern during normal operation of the tool. The controller can drive the motor to rotate the motor shaft in a second pattern to enable the acoustic plate to vibrate and output a haptic signal to the gripping portion that can be felt by the operator.

According to another aspect of various examples of the present disclosure, there is provided a method of providing haptic feedback that can be detected by an operator of a power tool.

According to another aspect of various examples of the present disclosure, there is provided a method of providing haptic feedback. The method includes powering a motor to drive a working portion in a first direction and measuring a position of the working portion with a sensor. The method also includes communicating the position to a processor and sending first instructions from the processor to a controller when the position exceeds a first threshold. The method also includes driving a motor shaft in accordance with the first instructions to move in a first pattern. The movement in the first pattern produces a first haptic output that can communicate a first alert.

According to another aspect of various examples of the present disclosure, there is provided a method of providing haptic feedback. A motor is powered to drive a portion of a handheld power tool. An operational state of the handheld power tool is measured with a sensor. The operational state is communicated to a processor. First instructions are sent from the processor to a controller when the operational state exceeds a first threshold. A motor shaft is driven in accordance with the first instructions to move in a first pattern. Movement in the first pattern produces a first haptic output that can communicate a first alert.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompanying drawing wherein:

FIG. 1 is a perspective view of a handheld power tool.

FIG. 2 is a perspective view of a motor of the power tool of FIG. 1.

FIG. 3 is a perspective view of an acoustic plate coupled to the motor of FIG. 2.

FIG. 4 is a perspective view of the acoustic plate of FIG. 3, vibrating at a resonance frequency.

FIG. 5 is a schematic view of a control system of the power tool of FIG. 1.

FIG. 6 is a flow chart illustrating the steps of providing an alert in the power tool of FIG. 1.

### DETAILED DESCRIPTION

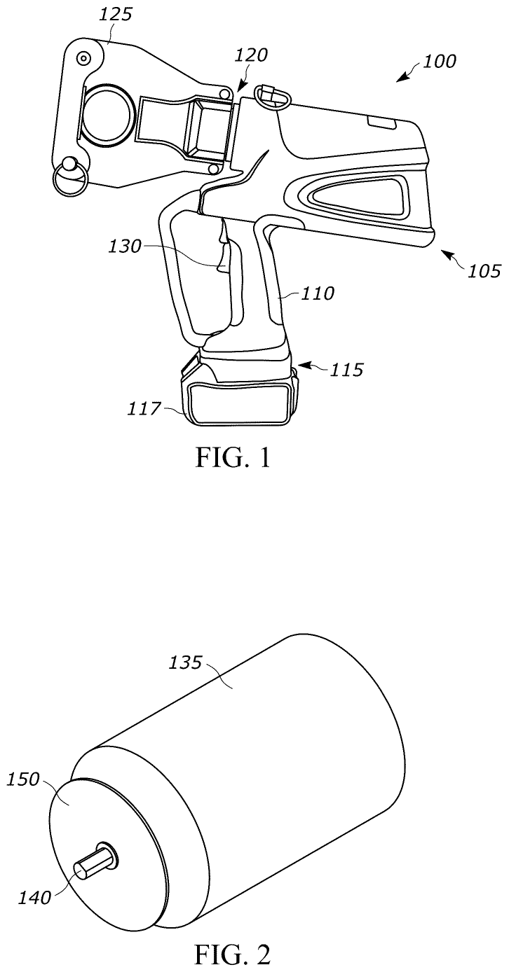

FIG. 1 shows a power tool 100 (e.g., a handheld power tool). The illustrated power tool 100 may be used to perform a crimping operation, but power tools with other types of functions may also be used.

In some forms, the power tool 100 includes a body 105 that is formed from an outer casing or shell 110. The illustrated shell 110 may be constructed from a first material, like a rigid plastic, although materials may be used.

The body 105 may include a first end 115 and a second end 120. The first end 115 may include an electrical connection where a power source 117 (e.g., a power tool battery pack) may removably connect and provide electrical power. In other examples, an electrical cord may extend from the first end 115 to provide electrical power. The second end 120 may be spaced apart from the first end 115. A working portion 125 may be coupled to the second end 120. As described in more detail below, the working portion 125 may perform a crimping operation during use of the power tool 100.

In some forms, the power tool 100 may have a pistol-style shape. In this example, the first end 115 may be oriented in a different direction than the second end 120. For example, the second end 120 may be offset from the first end by approximately 90 degrees. Although in other examples, the angle between the first and second ends 115, 120 may be different or adjustable.

In some forms, the shell 110 may include a section that is constructed from a second material that is different than the first material. In the illustrated example, the second material may be disposed proximate to an actuator 130 (e.g., a trigger). The second material may help an operator grip the body 105. The second material may be a type of rubber or similar material. Alternatively or in addition, the portion of the shell 110 proximate to the actuator 130 may include a different texture than the remainder of the shell 110. The different texture may similarly assist in providing an operator with additional grip when using the power tool 100.

A motor 135 (see e.g., FIG. 2) may be supported within the casing 110. As described in more detail below, the motor 135 may drive the movement of the working portion 125. In some forms, the motor 135 may be a brushless motor, although another type of motor (e.g., a brushed motor) may be used.

In some forms, a shaft 140 may extend from the motor 135. The shaft 140 may be driven (e.g., to rotate) because of rotation of the motor 135. The shaft 140 may assist in transmitting energy from the motor 135 to the working portion 125.

In certain forms, the shaft 140 may include a keyed shape. For example, the shaft 140 may include a substantially planar outer surface that extends around at least part of the outer perimeter. For example, the illustrated shaft 140 may include a planar section and a curved section. In other examples, the shaft 140 may have another shape.

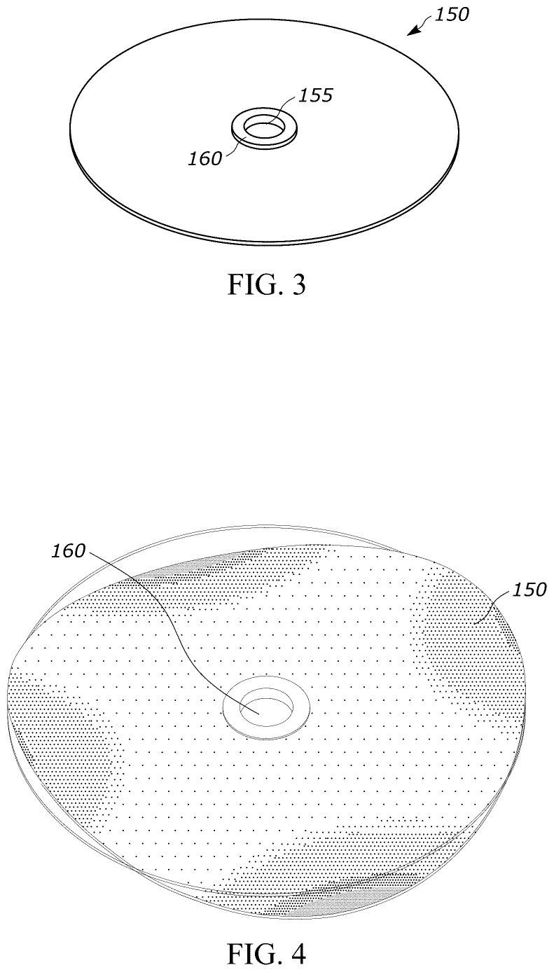

As shown in FIGS. 2 to 4, a plate 150 (e.g., an acoustic plate) may have a substantially round outer perimeter (e.g., a substantially circular shape), although other shapes may be used. The plate 150 may also include an inner aperture 155, which may be disposed at a center of the plate 150. The plate 150 may therefore have a disk shape.

In the illustrated example, the inner aperture 155 may have a substantially circular shape, although other shapes may be used. The width of the inner aperture 155 may be approximately the same size as an outer dimension of the shaft 140.

In some forms, the plate 150 may include a raised portion 160 that surrounds the inner aperture 155. The illustrated raised portion 160 may be thicker than the remainder of the plate 150. The raised portion 160 may assist the plate 150 in remaining coupled to the shaft 140 (although other examples may not include the raised portion 160).

The plate 150 may be formed from an at least partially rigid material (e.g., metal), although the plate may be constructed from any material that can produce vibrational movement.

As shown in FIG. 2, the plate 150 may be coupled to the shaft 140. For example, the shaft 140 may be received by the inner aperture 155 of the plate 150. In some forms, the width of the inner aperture 155 may snuggly accommodate the outer dimension of the shaft 140. This may limit the plate 150 from inadvertently translating along a length of the shaft 140.

In some forms, the keyed shape of the shaft 140 may permit some relative movement between the plate 150 and the shaft 140. As described in more detail below, the space between the inner aperture 155 and the shaft 140 may permit movement (e.g., vibrational movement) between the plate 150 and the shaft 140.

In other examples, the plate 150 may be disposed in other portions of the body 105. For example, the plate 150 coupled be disposed within and/or coupled to a gearbox (not shown) that includes one or more gears driven by the motor 135. Even if not positioned around the shaft, the plate 150 may be indirectly coupled to the motor 135. Alternatively, the plate 150 could be positioned at any location within the body 105 where propagation of vibrational waves is possible. Vibrational output from the motor 135 may still vibrate the plate 150 even if the two are not directly connected. In some examples, this may permit a technician to retrofit an existing power tool with a plate 150 to enable the user to experience the haptic response.

In use, an operator may drive the motor 135 by engaging the actuator 130. This may cause the motor shaft 140 to rotate, which will drive the working portion 125. The illustrated power tool 100 may be a crimping tool, and the rotation of the motor shaft 140 may drive the jaws of the working portion 125 together to form a crimp.

In some forms, the jaws of the working portion 125 may continue to move together as long as the operator continues to engage the actuator. For example, some power tools 100 may include hydraulic mechanisms (e.g., a piston) that may move toward an extended position while an actuator 130 is engaged and may return to a retracted position when the actuator 130 is released. A piston therefore may not return to a retracted position (e.g., so that a new crimping procedure can occur) until the actuator 130 is released.

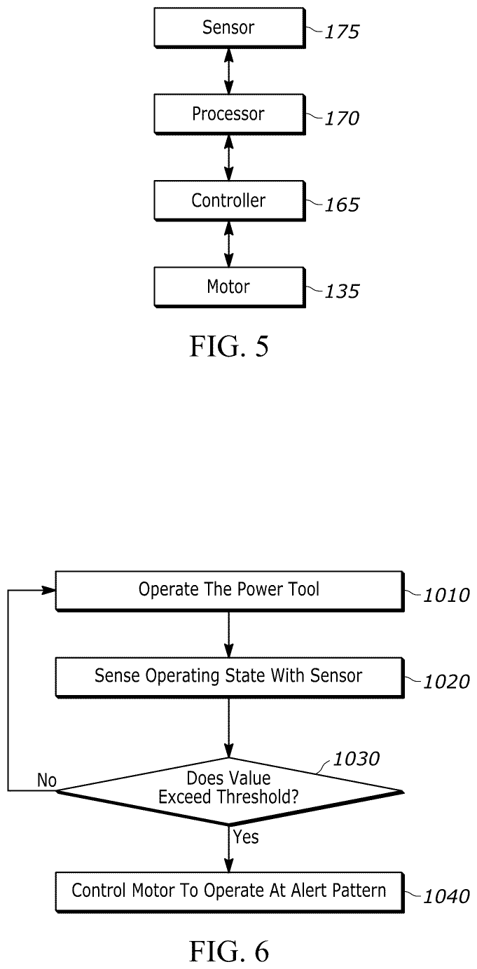

As shown in FIG. 5, the power tool 100 may include a controller 165, a processor 170, and a sensor 175. One or more of these elements may be connected to the motor 135 to monitor and/or control operation of the motor 135.

As shown in FIG. 6, the power tool may be operated 1010 and a sensor 175 may be a position sensor that can detect and/or measure 1020 a position of the working portion 125. Specifically, the sensor 175 may monitor the movement of the working portion toward the extended position. In other examples, the sensor 175 may measure another parameter or condition of the power tool 100. For example, the sensor 175 may measure motor speed, a temperature in the tool, or any other similar factor that can affect the overall performance of the tool 100. The sensor 175 may communicate the information to the processor 170, which may compare the information measured by the sensor 175 to one or more stored threshold values 1030. When the measured data exceeds the threshold, the processor 170 may communicate with the controller 165 to change the operation 1040 of the motor 135. For example, the controller 165 may control the motor 135 to change the speed and/or frequency at which the shaft 140 moves.

For example, the controller 165 may instruct the motor 135 to operate at a first alert pattern, where the motor may move fast and incrementally back and forth (e.g., modulating the frequency and/or amplitude of movement). As the motor 135 moves, the motor shaft 140 may vibrate. The plate 150 coupled to the shaft 140 may also vibrate. Specifically, the plate 150 may assist to amplify the vibration of the shaft 140.

In some forms, the controller 165 may control the motor 135 so that the plate 150 vibrates at its resonance frequency. As illustrated in FIG. 4, the plate 150 may flex to produce a vibrational output as a result of the movement of the motor shaft 140.

In some forms, the resonance frequency may be between about 1 Hz and about 3600 Hz. In some forms, the resonance frequency may be between about 100 Hz and about 3000 Hz. In some forms, the resonance frequency may be between about 500 Hz and about 2500 Hz. In some forms, the resonance frequency may be between about 1000 Hz and about 2000 Hz. In some forms, the resonance frequency may be about 1600 Hz. The instructions from the controller 165 may be paired with the material of the plate 150 so that the plate can vibrate at a predetermined frequency (e.g., a known resonance frequency).

In some forms, the processor 170 may store multiple thresholds. Exceeding any of these thresholds may cause the processor 170 to communicate with the controller 165 to operate the motor 135 in a different pattern. In other words, the motor 135 and motor shaft 140 can be controlled to operate at multiple different alert patterns. Each different alert pattern may cause the plate 150 to vibrate at a different frequency and/or amplitude, which in turn produces a different haptic pattern. Each of these patterns may communicate different information to the operator (e.g., current use conditions, service conditions, etc.).

As the plate 150 vibrates, it may be felt by the operator of the power tool 100. For example, the vibrations may travel through the shell 110 and can be felt by the operator. The presence of the vibration may alert the operator to adjust their action. For example, haptic response can alert the operator that the crimping cycle is complete, and that the operator can release the actuator 130. A haptic response may also be used to alert the operator to an error condition in the tool 100 so that the operator can repair or replace the tool 100. The plate 150 may be able to vibrate and produce multiple haptic outputs that are distinguishable to an operator to communicate different information.

The haptic alert system may be more effective that other types of alerts like visual alerts because an operator may miss the visual alerts while using the tool 100. However, the haptic response may be strong enough that the operator can feel the pattern of vibrations while using the tool 100 and can react in accordance with the information communicated by the vibrations.

In some forms, the haptic output of the plate 150 may be used in conjunction with other types of alert methods. For example, auditory (e.g., speakers) and/or visual (e.g., LEDs) alert methods may be used in addition to the haptic alert method to provide additional ways to alert the operator.

In certain forms, the auditory and/or visual alerts may be used to communicate the same information as the haptic alert. In other examples, the auditory and/or visual alerts may communicate different information. For example, plate 150 may vibrate at a single alert frequency. The operator can then check the auditory and/or visual alert for a more specific indication of the alert.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

1. A power tool comprising:
a housing having a gripping portion configured to be grasped by an operator;
a working portion coupled to the housing;
a motor supported in the housing and configured to drive the working portion;
an acoustic plate disposed within the housing; and
a controller configured to drive the motor;
wherein the acoustic plate is configured to vibrate during operation of the motor and transmit a haptic signal to the gripping portion that is configured to be felt by the operator.

2. The power tool of claim 1, wherein the motor is a brushless DC motor.

3. The power tool of claim wherein the acoustic plate is coupled to a shaft of the motor, and wherein the shaft of the motor has a keyed shape.

4. The power tool of claim 1, wherein the acoustic plate is configured to produce the haptic signal at a predetermined resonance between 1000 Hz and 2000 Hz.

5. The power tool of claim 1, wherein the acoustic plate is disposed within a gearbox disposed within the housing, wherein the gearbox includes at least one gear configured to be driven by the motor.

6. The power tool of claim 1, further comprising a sensor electrically connected to the controller, wherein the sensor is configured to sense a first condition indicative of performance and the controller is configured to drive the motor at a first speed to enable the acoustic plate to vibrate at a first pattern, and wherein the first pattern is configured to communicate the first condition.

7. The power tool of claim 6, wherein the sensor is configured to sense a second condition indicative of performance and the controller is configured to drive the motor at a second speed to enable the acoustic plate to vibrate at a second pattern, and wherein the second pattern is configured to communicate the second condition.

8. A power tool comprising:
a movable working portion;
a motor including a drive shaft coupled to the working portion and configured to drive movement of the working portion;
an acoustic plate coupled to the drive shaft; and
a controller configured to drive the motor;
wherein the acoustic plate is configured to vibrate during rotation of the drive shaft and output a haptic signal that is configured to communicate an operational state.

9. The power tool of claim 8, wherein the motor is a brushless DC motor.

10. The power tool of claim 8, wherein the acoustic plate is configured to produce the haptic signal at a predetermined resonance between 1000 Hz and 2000 Hz.

11. The power tool of claim 10, wherein the predetermined resonance is 1600 Hz.

12. The power tool of claim 8, further comprising a sensor electrically connected to the controller, wherein the sensor is configured to sense a first condition indicative of performance and the controller is configured to drive the motor at a first speed to enable the acoustic plate to vibrate at a first pattern, and wherein the first pattern is configured to communicate the first condition.

13. The power tool of claim 12, wherein the sensor is configured to sense a second condition indicative of performance and the controller is configured to drive the motor at a second speed to enable the acoustic plate to vibrate at a second pattern, and wherein the second pattern is configured to communicate the second condition.

14.-26. (canceled)

27. A power tool comprising:
a housing having a gripping portion configured to be grasped by an operator;
a motor supported in the housing and having an asymmetrical motor shaft;
an acoustic plate coupled to the motor shaft; and
a controller electrically coupled to the motor;
wherein the controller is configured to drive the motor to rotate the motor shaft in a first pattern during normal operation of the tool; and
wherein the controller is configured to drive the motor to rotate the motor shaft in a second pattern to enable the acoustic plate to vibrate and output a haptic signal to the gripping portion that is configured to be felt by the operator.

28. The power tool of claim 27, wherein the motor is a brushless DC motor.

29. The power tool of claim 27, wherein the acoustic plate is configured to produce the haptic signal at a predetermined resonance between 1000 Hz and 2000 Hz.

30. The power tool of claim 27, further comprising a sensor electrically connected to the controller, wherein the sensor is configured to sense a first condition indicative of performance and the controller is configured to drive the motor in the second pattern to enable the acoustic plate to output the haptic signal and communicate the first condition.

31. The power tool of claim 30, wherein the sensor is configured to sense a second condition indicative of performance and the controller is configured to drive the motor at a third pattern to enable the acoustic plate to output a second haptic signal and communicate the second condition.

32. The power tool of claim 27, wherein the motor shaft has a keyed shape with a planar outer surface.

33. The power tool of claim 32, wherein the acoustic plate has a central opening that receives the motor shaft, and wherein the central opening has a circular shape.
